(19) United States
(12) Patent Application Publication
(10) Pub. No.: US 2009/0027457 A1
(43) Pub. Date: Jan. 29, 2009

(54) Fluid ejection device

(76) Inventor: Garrett E. Clark, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/880,984

(22) Filed: Jul. 25, 2007

(51) Int. Cl. B41J 2/04; B41J 2/05

(52) U.S. Cl. 347/65

(57) ABSTRACT

Embodiments of a fluid ejection device are disclosed.

### INTRODUCTION

Inkjet printing technology generally uses a fluid ejection device, commonly referred to as a printhead, which has a plurality of orifices or nozzles through which the drops of printing fluid are ejected. Various factors limit the firing frequency of a printhead.

### DESCRIPTION OF THE DRAWINGS

FIG. 1 is a perspective view of one embodiment of an inkjet pen.

FIG. 2 is a cross-sectional side view of one embodiment of a fluid ejection device such as a printhead.

FIG. 3 is a partially cutaway isometric view of one embodiment of the printhead.

FIG. 4 is a partial cross-sectional view of one embodiment of the printhead taken along line 4-4 of FIG. 2.

### DETAILED DESCRIPTION

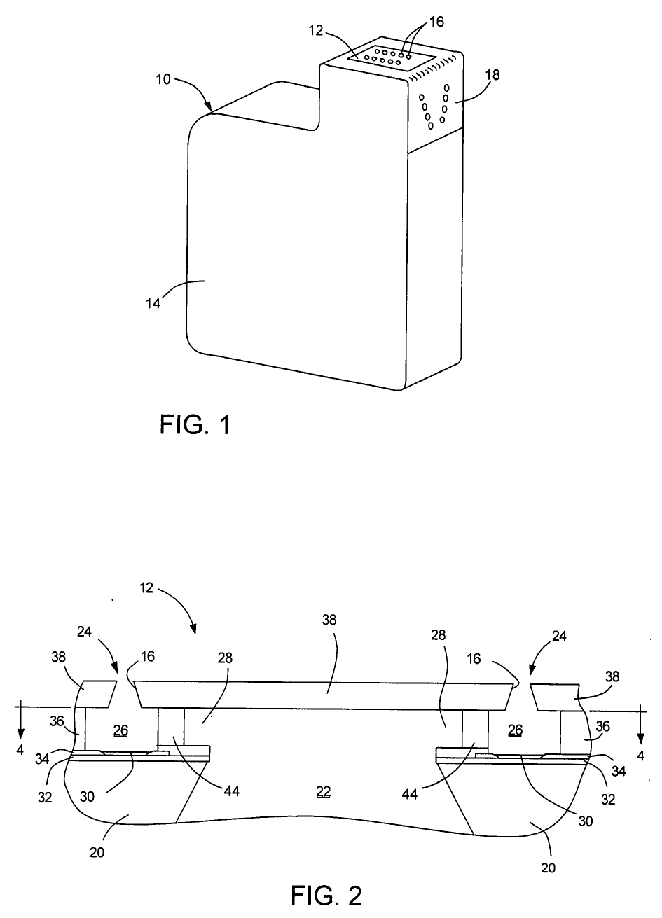

Referring to the drawings wherein identical reference numerals denote the same elements throughout the various views, FIG. 1 shows an illustrative embodiment of an inkjet pen 10 having a fluid ejection device in the form of a printhead 12. The pen 10 includes a body 14 that generally contains a printing fluid supply. As used herein, the term “printing fluid” refers to any fluid used in a printing process, including but not limited to inks, preconditioners, fixers, etc. Other possible embodiments include fluid ejection devices that eject fluids other than printing fluid.

The printing fluid supply can comprise a fluid reservoir wholly contained within the pen body 14 or, alternatively, can comprise a chamber inside the pen body 14 that is fluidly coupled to one or more off-axis fluid reservoirs (not shown). The printhead 12 is mounted on an outer surface of the pen body 14 in fluid communication with the printing fluid supply. The printhead 12 ejects drops of printing fluid through a plurality of nozzles 16 formed therein. Although a relatively small number of nozzles 16 is shown in FIG. 1, the printhead 12 may have two or more columns with more than one hundred nozzles per column, as is common in the printhead art. Appropriate electrical connectors 18 (such as a tape automated bonding “flex tape”) are provided for transmitting signals to and from the printhead 12.

Referring to FIGS. 2-4, the printhead 12 includes a substrate 20 having at least one fluid feed hole 22 formed therein with a plurality of drop generators 24 arranged around the fluid feed hole 22. The fluid feed hole 22 is an elongated slot in fluid communication with the printing fluid supply. Each drop generator 24 includes one of the nozzles 16, a firing chamber 26, a feed channel 28 establishing fluid communication between the fluid feed hole 22 and the firing chamber 26, and a fluid ejector 30 disposed in the firing chamber 26. The fluid ejectors 30 can be any device, such as a resistor or piezoelectric actuator, capable of being operated to cause drops of fluid to be ejected through the corresponding nozzle 16.

In the illustrated embodiment, an oxide layer 32 is formed on a front surface of the substrate 20, and a thin film stack 34 is applied on top of the oxide layer 32. The thin film stack 34 generally includes an oxide layer, a metal layer defining the fluid ejectors 30 and conductive traces, and a passivation layer. A barrier layer 36 that defines the firing chambers 26 and the feed channels 28 is formed on top of the thin film stack 34. An orifice layer 38 that defines the nozzles 16 is formed on top of the barrier layer 36. Although FIGS. 2-4 illustrate one possible printhead configuration, namely, two rows of drop generators about a common feed hole, it should be noted that other configurations may be used in the practice of the present disclosure. For example, another possible printhead configuration, referred to as an edge-feed architecture, has drop generators arranged along the side edges of the substrate. In this case, printing fluid flows over the side edges and into the feed channels.

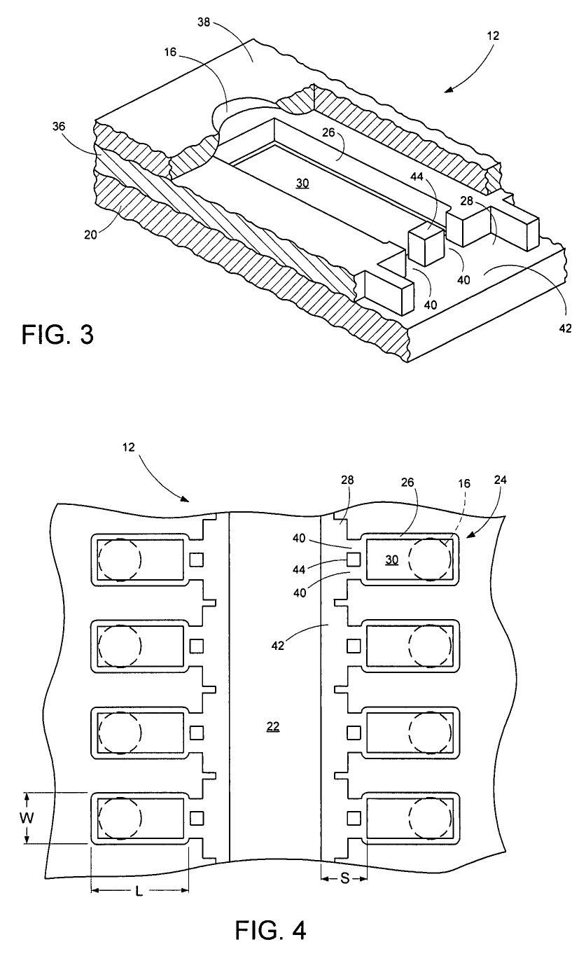

As best seen in FIGS. 3 and 4, each feed channel 28 has two short, narrow passages 40 that extend from the main portion of the feed channel 28 to the corresponding firing chamber 26. The passages 40 define separate, distinct inlets to the firing chamber 26 that are arranged to separately carry fluid. As used herein, “arranged to separately carry fluid” means that each one of the passages 40 has a distinct entrance fluidly connected to the main portion of the feed channel 28 and a distinct exit fluidly connected to the firing chamber 26. Printing fluid flows independently through the two passages 40; there is no interaction between printing fluid flowing through the respective passages until the fluid is in the firing chamber 26. The two passages 40 provide two separate, damped flows of printing fluid to the firing chamber 26. The respective axes of the passages 40 may not be parallel to one another, although they are shown that way in FIGS. 3 and 4. Although two passages 40 are shown in the illustrated embodiment, it should be noted that more than two such passages per drop generator could be utilized.

In the illustrated embodiment, the firing chambers 26 have a rectangular configuration with a back wall, two side walls and a front wall located nearest to the fluid feed hole 22. The area of the substrate 20 between the front wall and the fluid feed hole 22 (i.e., adjacent to the front wall) is referred to as the shelf region 42, and the shelf length S for a given drop generator 24 is the distance between the front of the fluid ejector 30 and the edge of the fluid feed hole 22. The passages 40 are both formed in the front wall of the firing chamber 26 and are separated by an island 44. The combined width of the two passages 40 and the island 44 is less than the width W of the firing chamber 26. That is, the passages 40 are located side-by-side and are spaced apart so as to define a lateral distance that is less than the width W of the firing chamber 26. To take advantage of this narrow spacing, the firing chamber 26 can be provided with a minimal width W, which is significantly less than the firing chamber length L. Such a narrow firing chamber would leave an area of stagnant printing fluid near the back wall if the fluid ejector 30 were centered underneath the nozzle 16. Accordingly, each nozzle 16 (depicted in dashed lines in FIG. 4) is offset from the center of the corresponding fluid ejector 30. Each drop generator 24 is also provided with a short shelf length S. The shelf length S is less than the firing chamber length L in the illustrated embodiment.

In another possible embodiment, the passages 40 are not located side-by-side but are arranged vertically, one over the other. In this case, the passages 40 would still define or occupy a lateral distance that is less than the width W of the firing chamber 26. The passages 40 could also be arranged diagonally, that is, not aligned vertically or laterally.

In operation, a droplet of printing fluid is ejected from a selected nozzle 16 by activating the corresponding fluid ejector 30. The firing chamber 26 is then refilled with printing fluid, which flows from the fluid feed hole 22 and over the shelf region 42 (or over the side edges of the substrate in the case of an edge-feed architecture) and then through the feed channel 28 and passages 40. For example, in the instance where the fluid ejectors 30 are resistors, a resistor is energized with a pulse of electric current. The resulting heat from the resistor 30 creates a vapor bubble in the corresponding firing chamber 26 that quickly expands and forces a droplet of printing fluid through the corresponding nozzle 16. The expanding bubble also pushes printing fluid backward in the feed channel 28 toward the printing fluid supply. The collapsing bubble pulls printing fluid through the feed channel 28, partially refilling the firing chamber 26. Firing chamber refill is completed by capillary action. As the firing chamber 26 is filled with printing fluid, the fluid forms a meniscus in the nozzle 16. The kinetic energy of the fluid pushes against the meniscus, causing it to bulge, and the surface tension in the meniscus pushes the bulging fluid back into the firing chamber 26. The meniscus thus behaves like a naturally damped membrane that seeks equilibrium undergoing simple harmonic oscillations. The oscillations continue until viscous losses dissipate the kinetic energy and the system comes to rest. At equilibrium, a constant volume of printing fluid is present.

Ejecting a droplet while the meniscus is still oscillating can result in a condition known as meniscus overshoot. Specifically, if a drop is ejected when the meniscus is bulging out (i.e., meniscus overshoot), the resulting drop will have a higher drop weight and a lower drop velocity. Meniscus overshoot leaves excess liquid on the printhead surface that can interfere with proper droplet ejection, even stopping droplet ejection altogether in extreme cases.

By nature of their small cross-sectional areas, the two passages 40 function as constrictions or pinch points that provide viscous damping, which reduces meniscus oscillations and overshoot. By using two or more pinch point passages 40, rather than a single pinch point, the velocity of the printing fluid flowing through the feed channel 28 is relatively low without sacrificing viscous drag. A lower fluid velocity means that the kinetic energy (which is determined by ½ mV², where m is mass and V is velocity) of the moving printing fluid is lower. In addition, the short shelf length means that the mass of moving printing fluid is less, further reducing the kinetic energy. Reducing the kinetic energy for a given amount of viscous drag reduces meniscus oscillations and overshoot. In other words, this lower kinetic energy allows the oscillating meniscus that occurs during refill to come to rest more quickly than with a single pinch point having similar viscous drag.

Reducing kinetic energy by keeping fluid velocity low and providing a short shelf length thus reduces meniscus overshoot. Having a low meniscus overshoot means that less viscous drag is used, so the length of the pinch point passages 40 can be decreased, which will increase refill speed.

In summary, use of multiple pinch point passages arranged to separately carry fluid decreases meniscus overshoot without sacrificing refill speed, and providing a short shelf length increases refill speed without increasing meniscus overshoot. Thus, using these two features in unison speeds firing chamber refill and reduces meniscus overshoot. The present disclosure is thus able to optimize printhead performance without making a trade off between refill speed and meniscus overshoot.

While specific embodiments of the present disclosure have been described, it should be noted that various modifications thereto can be made without departing from the spirit and scope of the subject matter recited in the appended claims.

What is claimed is:

1. A fluid ejection device comprising:
a substrate defining a shelf region; and
a plurality of drop generators formed on said substrate, each drop generator including a firing chamber and a channel that establishes fluid communication between said shelf region and said firing chamber, said channel having at least two separate inlets into said firing chamber that are arranged to separately carry fluid.

2. The fluid ejection device of claim 1 wherein each chamber has a width and said inlets define a lateral distance that is less than said chamber width.

3. The fluid ejection device of claim 1 wherein each chamber is defined by a plurality of walls, a first one of said walls being located adjacent to said shelf region, and wherein said two inlets are both formed in said first wall.

4. The fluid ejection device of claim 1 wherein each chamber has a length and said shelf region defines a shelf length, and wherein said shelf length is less than said chamber length.

5. The fluid ejection device of claim 1 wherein said substrate includes a feed hole formed therein and said drop generators are arranged around said feed hole.

6. The fluid ejection device of claim 1 wherein each drop generator includes a fluid ejector disposed in its firing chamber.

7. The fluid ejection device of claim 6 wherein each fluid ejector is a resistor.

8. The fluid ejection device of claim 1 wherein each drop generator includes a nozzle.

9. The fluid ejection device of claim 1 wherein each nozzle is offset with respect to its corresponding fluid ejector.

10. A printhead comprising:
a firing chamber having a width and a length;
a channel for conveying printing fluid;
a first passage extending from said channel to said firing chamber; and
a second passage extending from said channel to said firing chamber separately from said first passage, said first and second passages defining a lateral distance that is less than said width of said firing chamber.

11. The printhead of claim 10 wherein said firing chamber has a back wall, two side walls and a front wall, and said first and second passages are both formed in said front wall.

12. The printhead of claim 11 further comprising a shelf region located adjacent to said front wall, said shelf region defining a shelf length.

13. The printhead of claim 12 wherein said shelf length is than said length of said firing chamber.

14. The printhead of claim 11 wherein said first and second passages are located side-by-side in said front wall.

15. The printhead of claim 10 wherein said length of said firing chamber is greater than said width of said firing chamber.

16. The printhead of claim 10 further comprising a fluid ejector disposed in said firing chamber.

17. The printhead of claim 16 wherein said fluid ejector is a resistor.

18. The printhead of claim 16 further comprising a nozzle in fluid communication with said firing chamber.

19. The printhead of claim 18 wherein said nozzle is offset with respect to said fluid ejector.

20. A fluid ejection device comprising:
a firing chamber; and
means for conveying at least two separate, damped flows of fluid to said firing chamber to decrease meniscus overshoot without sacrificing refill speed.
